(19) United States
(12) Patent Application Publication
(10) Pub. No.: US 2025/0358860 A1
(43) Pub. Date: Nov. 20, 2025

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 18/872,008

(22) PCT Filed: Jun. 15, 2022
(86) PCT No.: PCT/CN2022/098883

§ 371 Date: Dec. 5, 2024

(51) Int. Cl. H04W 74/0833; H04W 74/0808

(52) U.S. Cl. CPC H04W 74/0833; H04W 74/0808

(57) ABSTRACT

Embodiments of the present disclosure relate to methods, devices and computer readable media of communication. A terminal device stores and transmits information of a RA procedure to a network device. The information of the RA procedure comprises at least one of the following: information regarding RA partition, information regarding Msg3 repetition, information regarding a TA report, or information regarding the RA procedure triggered due to none of SSBs associated with a CG resource for SDT has RSRP above threshold power, or due to consistent LBT failure recovery, or due to SCG activation, or due to BFR for two sets of BFD-RSs. In this way, a RA configuration may be optimized.

### TECHNICAL FIELD

Embodiments of the present disclosure generally relate to the field of telecommunication, and in particular, to methods, devices and computer storage media of communication for self-organizing network (SON) enhancement.

### BACKGROUND

SON encompasses solutions for network self-configuration and self-optimization and is introduced to support deployment of system and performance optimization. One of SON features is to report random access (RA) related information to a network such that the network may adjust a RA configuration for better performance. Recently, multiple work items (WIs) make enhancements on a RA procedure, and also introduce RA partitioning across multiple WIs. Thus, some further enhancements are required for the SON feature with regarding to RA related information reporting.

### SUMMARY

In general, embodiments of the present disclosure provide methods, devices and computer storage media of communication for reporting RA information for SON enhancement.

In a first aspect, there is provided a method of communication. The method comprises: storing, at a terminal device, information of a random access procedure; and transmitting the information of the random access procedure to a network device, the information of the random access procedure comprising at least one of the following: first information regarding random access partition, second information regarding Message 3 repetition, third information regarding the random access procedure triggered due to none of synchronization signal and physical broadcast channel blocks associated with a configured grant resource for small data transmission has reference signal receiving power above threshold power, fourth information regarding the random access procedure triggered due to consistent listen before talk failure recovery, fifth information regarding the random access procedure triggered due to secondary cell group activation, sixth information regarding the random access procedure triggered due to beam failure recovery for two sets of reference signals for beam failure detection, or seventh information regarding a timing advance report.

In a second aspect, there is provided a method of communication. The method comprises: receiving, at a network device and from a terminal device, information of a random access procedure comprising at least one of the following: first information regarding random access partition, second information regarding Message 3 repetition, third information regarding the random access procedure triggered due to none of synchronization signal and physical broadcast channel blocks associated with a configured grant resource for small data transmission has reference signal receiving power above threshold power, fourth information regarding the random access procedure triggered due to consistent listen before talk failure recovery, fifth information regarding the random access procedure triggered due to secondary cell group activation, sixth information regarding the random access procedure triggered due to beam failure recovery for two sets of reference signals for beam failure detection, or seventh information regarding a timing advance report.

In a third aspect, there is provided a device of communication. The device comprises a processor configured to cause the device to perform the method according to any of the first and second aspects of the present disclosure.

In a fourth aspect, there is provided a computer readable medium having instructions stored thereon. The instructions, when executed on at least one processor, cause the at least one processor to perform the method according to any of the first and second aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication for reporting RA information according to embodiments of the present disclosure;

FIG. 3 illustrates an example method of communication implemented at a terminal device in accordance with some embodiments of the present disclosure;

FIG. 4 illustrates an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Recently, an objective of study item (SI) or core part WI or testing part WI is to specify data collection enhancement in new radio (NR) for SON/minimization of drive test (MDT) purpose. The specific objectives of this WI are:
support of data collection for SON features, including “left-over” features (i.e. MR-DC conditional PSCell change (CPC) or conditional PSCell addition (CPA) and maintenance, repair, operation (MRO) successful PSCell change report, fast master cell group (MCG) recovery, new radio in unlicensed spectrum (NR-U)) and MRO enhancement for inter-system handover voice fallback.
specification of UE reporting necessary to enhance the mobility parameter tuning.
specification of inter-node information exchange, including possible enhancements to interfaces.
support of SON/MDT enhancements for RA enhancements.

Embodiments of the present disclosure provide a solution of reporting RA information for SON enhancements. In the solution, a terminal device stores and reports RA information comprising at least one of the following: information of RA partition, information of Message 3 (Msg3) repetition, information of a timing advance (TA) report, information of a RA procedure triggered due to none of synchronization signal and physical broadcast channel blocks (SSBs) associated with a configured grant (CG) resource for small data transmission (SDT) has reference signal receiving power (RSRP) above threshold power, information of a RA procedure triggered due to consistent listen before talk (LBT) failure recovery, information of a RA procedure triggered due to secondary cell group (SCG) activation, or information of a RA procedure triggered due to beam failure recovery (BFR) for two sets of reference signals for beam failure detection (BFD-RSs).

In this way, RA information may be reported to a network in a more comprehensive way and a RA configuration may be optimized accordingly.

Principles and implementations of the present disclosure will be described in detail below with reference to the figures.

### Example of Communication Network

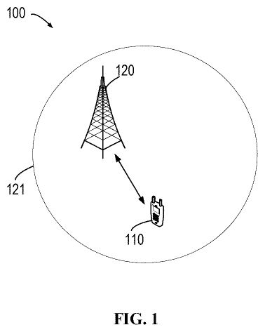

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 121 to serve one or more terminal devices. In this example, the terminal device 110 is located in the cell 121 and is served by the network device 120.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 110 may initiate a RA procedure to the network device 120. In some embodiments, the terminal device 110 may perform a 2-step RA procedure to the network device 120. In some embodiments, the terminal device 110 may perform a 4-step RA procedure to the network device 120. In these embodiments, when the RA procedure is completed successfully, the terminal device 110 may transmit a RA report to the network device 120. The RA report may comprise information of the RA procedure. The information of the RA procedure may comprise RA common information and a RA purpose. The RA common information may indicate physical layer configuration information for the RA procedure, for example, message 1 (Msg1) configuration related information and message A (MsgA) configuration related information. The RA common information may also indicate information of each RA attempt during the RA procedure. The RA purpose may indicate a reason or scenario the RA procedure is triggered.

In some embodiments, the terminal device 110 may initiate a RA procedure for connection establishment with the network device 120. If the connection establishment fails, the terminal device 110 may transmit a connection establishment failure report to the network device 120. The connection establishment failure report may comprise information of each RA attempt during the RA procedure.

In some embodiments, for a radio link failure (RLF) or handover failure, the terminal device 110 may transmit a RLF report to the network device 120. The RLF or handover failure may be caused due to problem or failure of a RA procedure. The RLF report may comprise information of RA associated with the RLF or handover failure. The information of the RA procedure may comprise RA common information.

In some embodiments, the terminal device 110 may initiate a RA procedure for a successful handover, the terminal device 110 may transmit a success handover report (SHR) to the network device 120. The SHR report may comprise information of the RA procedure during the successful handover. The information of the RA procedure may comprise RA common information.

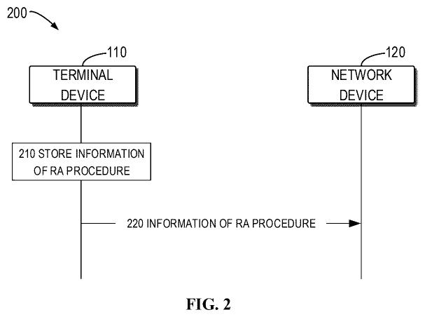

Embodiments of the present disclosure provide a solution of reporting RA information for SON enhancements. More details of the solution will be described with reference to FIG. 2.

### Example Implementation of RA Information Reporting

FIG. 2 illustrates a schematic diagram illustrating a process 200 of communication for reporting RA information according to embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the terminal device 110 may store 210 information of a RA procedure. In some embodiments, the information of the RA procedure may comprise information (for convenience, also referred to as first information) regarding RA partition. In some embodiments, the information of the RA procedure may comprise information (for convenience, also referred to as second information) regarding Msg3 repetition. In some embodiments, the information of the RA procedure may comprise information (for convenience, also referred to as third information) regarding the RA procedure triggered due to none of SSBs associated with a CG resource for SDT has RSRP above threshold power. In some embodiments, the information of the RA procedure may comprise information (for convenience, also referred to as fourth information) regarding the RA procedure triggered due to consistent LBT failure recovery. In some embodiments, the information of the RA procedure may comprise information (for convenience, also referred to as fifth information) regarding the RA procedure triggered due to SCG activation. In some embodiments, the information of the RA procedure may comprise information (for convenience, also referred to as sixth information) regarding the RA procedure triggered due to BFR for two sets of BFD-RSs. In some embodiments, the information of the RA procedure may comprise information (for convenience, also referred to as seventh information) regarding a TA report. It is to be understood that any combination of the above information and any other suitable information are also feasible.

With reference to FIG. 2, the terminal device 110 may transmit 220 the information of the RA procedure to the network device 120. In some embodiments, the terminal device 110 may transmit the information of the RA procedure in a RA report. In some embodiments, the terminal device 110 may transmit the information of the RA procedure in a connection establishment failure report. In some embodiments, the terminal device 110 may transmit the information of the RA procedure in a RLF report. In some embodiments, the terminal device 110 may transmit the information of the RA procedure in a SHR. In some embodiments, the terminal device 110 may transmit the information of the RA procedure in a RA common information information element (IE).

For illustration, some example embodiments will be described in connection with Embodiments 1 to 7.

### Embodiment 1

In some scenarios, RA partitioning is considered for several features to enable early identification of the features on the network device 120. The network device 120 may associate a set of RA resources with feature(s) applicable to a RA procedure: a set of RA resources associated with a feature is only valid for RA procedures applicable to that feature; and a set of RA resources associated with several features is only valid for RA procedures having at least all of these features. The terminal device 110 may select the set(s) of applicable RA resources as below, after uplink carrier (i.e., normal uplink (NUL) or supplementary uplink (SUL)) and bandwidth part (BWP) selection and before selecting a RA type.
1. If contention-free random access (CFRA) resources are available to a current RA procedure or the RA procedure is not initiated for any feature, only sets of RA resources not associated with any feature can be used.
2. If a set of RA resources associated with all the features applicable to the current RA procedure exists, that set of RA resources is used.
3. If the features applicable at initiation of the current RA procedure have no RA resources associated, the terminal device 110 may consider features subset and their associated RA resource sets based on a priority order configured for the features by the network device 120. The first subset in priority order for which there are RA resources set associated, is selected.
4. If there are no RA resources associated with any of the features applicable to the current RA procedure, the sets of RA resources not associated with any feature are used.

As an example (for convenience, also referred to as Example 1 herein), applicable features for a RA procedure are reduced capability (RedCap)+SDT. Configured priorities (from high to low) are: coverage enhancement (CovEnh)>RedCap>Slice Group (SliceX)>SDT. Configured RA resource sets are: legacy resource set, a RA resource set for RedCap, a RA resource set for RedCap+SliceX+SDT, a RA resource set for SliceX+SDT, a RA resource set for SliceX, or a RA resource set for SDT. It is assumed that there are no available CFRA resources. It can be seen that there are no set of RA resources associated with both RedCap and SDT. As priority for RedCap is higher than priority for SDT, the configured RA resource set for RedCap will be selected for a RA procedure.

Currently, RA information stored by a terminal device and reported to a network does not comprise RA partition related information. Thus, the network cannot optimize a configuration for RA partition.

In view of this, embodiments of the present disclosure provide a solution of reporting information (i.e., the first information) regarding RA partition. In some embodiments, the terminal device 110 may store and report the information regarding RA partition for a RA report, a connection establishment report, RLF report or SHR. It is to be understood that the terminal device 110 may store and report the first information for any other suitable reports.

In some embodiments, the information regarding RA partition may comprise a set of features associated with a set of RA resources selected for the RA procedure. In some embodiments, a feature in the set of features may be SDT, RedCap, CovEnh or a list of slice group. With reference to the above Example 1, the set of features associated with the set of RA resources selected for the RA procedure comprises RedCap. In some embodiments, the set of features is called feature combination.

With the set of features associated with the set of RA resources selected for the RA procedure, the network may be aware of a feature combination associated with RA resource, and thus may optimize RA configuration for this specific feature combination or RA partition.

In some embodiments, the information regarding RA partition may comprise a set of features applicable for the RA procedure but unassociated with a set of RA resources selected for the RA procedure. With reference to the above Example 1, the set of features applicable for the RA procedure but unassociated with a set of RA resources selected for the RA procedure comprises SDT.

With the set of features applicable for the RA procedure but unassociated with the set of RA resources selected for the RA procedure, the network may know that it is not able to provide a RA partition with all features a terminal device requires and may add RA partition providing the missing features if many terminal devices report this.

In some embodiments, the information regarding RA partition may comprise a set of features applicable for the RA procedure. With reference to the above Example 1, the set of features applicable for the RA procedure comprises RedCap and SDT.

With the set of features applicable for the RA procedure, the network may know that it is not able to provide a RA partition with all features a terminal device requires and may add RA partition providing the missing features if many terminal devices report this.

It is to be understood that the first information may also comprise any other suitable information or combination of information, and is not limited to the above examples.

### Embodiment 2

In some scenarios, aggregation of multiple slots with transport block (TB) repetition for Msg3 transmission may be supported on both NUL and SUL, applicable to contention based random access (CBRA) with a 4-step RA type. If configured, the terminal device 110 may request Msg3 repetition via a separate PRACH resource when RSRP of downlink (DL) path loss reference is lower than a configured RSRP threshold. That is, a RSRP threshold is set for a terminal device to determine if Msg3 repetition is applied for a RA procedure. If measured RSRP is below the RSRP threshold, Msg3 repetition can be applied. However, the RSRP threshold configured by a network may be not very good. For example, a terminal device who has measured RSRP above the RSRP threshold may experience RA failure frequently.

In view of this, embodiments of the present disclosure provide a solution of reporting information (i.e., the second information) regarding Msg3 repetition. In some embodiments, the terminal device 110 may store and report the information regarding Msg3 repetition for a RA report, a connection establishment report, RLF report or SHR. It is to be understood that the terminal device 110 may store and report the second information for any other suitable reports.

In some embodiments, the information regarding Msg3 repetition may comprise measured RSRP of a downlink path loss reference obtained upon determination of whether Msg3 repetition is applicable for the RA procedure.

It is to be understood that the second information may also comprise any other suitable information or combination of information, and is not limited to the above examples.

In this way, the network may be aware of a RSRP value when Msg3 repetition is determined. Further, based on other reported information like whether the RA procedure with msg3 repetition is successful or not, the network may adjust the RSRP threshold configured for Msg3 repetition.

### Embodiment 3

Currently, during subsequent transmission phase of CG based SDT, when none of SSBs associated with one CG resource for SDT is above a RSRP threshold (also referred to as threshold power herein) for SSB selection, a terminal device may trigger a RA procedure. Alternatively, when none of SSBs associated with one CG resource for SDT is above a RSRP threshold for SSB selection and if there is uplink (UL) data available for transmission, a terminal device may trigger a RA procedure. However, current RA information stored and reported by a terminal device cannot differentiate this scenario from other scenarios.

In view of this, embodiments of the present disclosure provide a solution of reporting information (i.e., the third information) regarding a RA procedure triggered due to none of SSBs associated with a CG resource for SDT has RSRP above threshold power. In some embodiments, the terminal device 110 may store and report the third information for a RA report, a connection establishment report or RLF report. It is to be understood that the terminal device 110 may store and report the third information for any other suitable reports.

In some embodiments, the third information may comprise an indication indicating that the RA procedure is triggered due to none of SSBs associated with the CG resource for SDT has RSRP above threshold power. For example, a new RA purpose may be introduced to indicate that the scenario of the RA procedure is the case of none of SSBs associated with one CG resource for SDT is above a RSRP threshold for SSB selection. In this way, the network may differentiate the concerned scenario of RA procedure from other scenarios.

In some embodiments, the third information may comprise an indication indicating that the RA procedure is triggered due to none of SSBs associated with the CG resource for SDT has RSRP above threshold power and there is UL data available for transmission. For example, a new RA purpose may be introduced to indicate that the scenario of the RA procedure is the case of none of SSBs associated with one CG resource for SDT is above a RSRP threshold for SSB selection and there is UL data available for transmission. In this way, the network may also differentiate the concerned scenario of RA procedure from other scenarios.

In some embodiments, the third information may comprise an index of a CG resource which has no associated SSBs above threshold power. In some embodiments, the third information may comprise information of SSBs associated with a CG resource which has no associated SSBs above threshold power. In this way, the network may be aware of which CG resource is unavailable during CG based SDT for a terminal device, and which SSB associated with the CG resource is below the threshold power. Then the network may further adjust a configuration of CG based SDT for the terminal device.

In some embodiments, the third information may comprise measured RSRP of SSBs associated with the CG resource upon the triggering of the RA procedure. In this way, the network may be aware of the SSB condition and adjust the RSRP threshold for SSB selection during CG based SDT.

It is to be understood that the third information may also comprise any other suitable information or combination of information, and is not limited to the above examples.

### Embodiment 4

In some scenarios, if a terminal device detects consistent LBT failure, a RA procedure may be initiated for consistent LBT failure recovery. However, current RA information stored and reported by a terminal device cannot indicate the scenario of a RA procedure for this case.

In view of this, embodiments of the present disclosure provide a solution of reporting information (i.e., the fourth information) regarding a RA procedure triggered due to consistent LBT failure recovery. In some embodiments, the terminal device 110 may store and report the fourth information for a RA report. It is to be understood that the terminal device 110 may store and report the fourth information for any other suitable reports.

In some embodiments, the fourth information may comprise an indication indicating the RA procedure is triggered due to consistent LBT failure recovery. For example, a new RA purpose may be introduced to indicate that the scenario of the RA procedure is the case of a RA procedure initiated for consistent LBT failure recovery.

It is to be understood that the fourth information may also comprise any other suitable information or combination of information, and is not limited to the above examples.

In this way, the network is able to difference the scenario of a RA procedure triggered for consistent LBT failure from other scenarios.

### Embodiment 5

In some scenarios, the network device 120 may activate and deactivate a configured SCG. SCG activation/deactivation is introduced for power saving. Upon SCG activation, a terminal device may need to initiate a RA procedure on a PSCell of the SCG when beam failure occurs or TAT timer is not running upon reception of SCG activation indication. However, current RA information stored and reported by a terminal device cannot indicate the scenario of RA procedure and detailed information for this case.

In view of this, embodiments of the present disclosure provide a solution of reporting information (i.e., the fifth information) regarding a RA procedure triggered due to SCG activation. In some embodiments, the terminal device 110 may store and report the fifth information for a RA report or a RLF report. It is to be understood that the terminal device 110 may store and report the fifth information for any other suitable reports.

In some embodiments, the fifth information may comprise an indication indicating the RA procedure is triggered due to SCG activation. For example, a new RA purpose may be introduced to indicate that the scenario of the RA procedure is the case of a RA procedure initiated for SCG activation. In this way, the network is able to differentiate the scenario of a RA procedure triggered for SCG activation from other scenarios.

In some embodiments, the fifth information may comprise an indication indicating whether a beam failure occurs when RA for SCG activation is triggered. The beam failure means BFI COUNTER>beamFailureInstanceMaxCount. In some embodiments, the fifth information may comprise an indication indicating whether a time alignment timer (TAT) expiries or uplink un-synchronization occurs when a RA procedure for SCG activation is triggered. In this way, the network is able to be aware of a reason of triggering the RA procedure for SCG activation.

It is to be understood that the fifth information may also comprise any other suitable information or combination of information, and is not limited to the above examples.

### Embodiment 6

In some scenarios, two BFD-RS sets may be configured for BFD for the terminal device 110. If a beam failure is detected for both BFD-RS sets, a RA procedure may be initiated for BFR of two BFD-RS sets. However, current RA information stored and reported by a terminal device cannot indicate the scenario of a RA procedure for this case.

In view of this, embodiments of the present disclosure provide a solution of reporting information (i.e., the sixth information) regarding a RA procedure triggered due to BFR for two sets of BFD-RSs. In some embodiments, the terminal device 110 may store and report the sixth information for a RA report or a RLF report. It is to be understood that the terminal device 110 may store and report the sixth information for any other suitable reports.

In some embodiments, the sixth information may comprise an indication indicating that the RA procedure is triggered due to the BFR for the two sets of BFD-RSs. For example, a new RA purpose may be introduced to indicate that the scenario of the RA procedure is the case of RA procedure initiated for BFR recovery for two set of BFD-RSs.

In some embodiments, the sixth information may comprise an identity (e.g., an additional physical cell identifier (PCI)) of a non-serving cell associated with one of the two sets of BFD-RSs.

In this way, the network is able to differentiate the scenario of a RA procedure triggered for BFR recovery for two sets of BFD-RSs, and be aware of the information of the non-serving cell.

It is to be understood that the sixth information may also comprise any other suitable information or combination of information, and is not limited to the above examples.

### Embodiment 7

In Non-Terrestrial Network (NTN) scenario, if configured by the network device 120, upon initiation of a RA procedure due to initial access from RRC idle, RRC Connection Resume procedure from RRC inactive, RRC Connection Re-establishment procedure, or reconfiguration with sync, a Timing Advance (TA) report may be triggered by the terminal device 110. For the TA report, a TA report MAC CE may be generated and sent to the network device 120. The TA report MAC CE may indicate an integer number of slots greater than or equal to the TA value. If the RA procedure fails finally, the failure of the RA procedure may be due to a TA compensation value provided by the network is not suitable, and the network is not able to be aware of an appropriate TA value.

In view of this, embodiments of the present disclosure provide a solution of reporting information (i.e., the seventh information) regarding a TA report. In some embodiments, the terminal device 110 may store and report the information regarding the TA report for a connection establishment report or RLF report. It is to be understood that the terminal device 110 may store and report the seventh information for any other suitable reports.

In some embodiments, the seventh information may comprise a TA value. In some embodiments, the seventh information may comprise the integer number of slots greater than or equal to the TA value.

It is to be understood that the seventh information may also comprise any other suitable information or combination of information, and is not limited to the above examples.

### Example Implementation of Methods

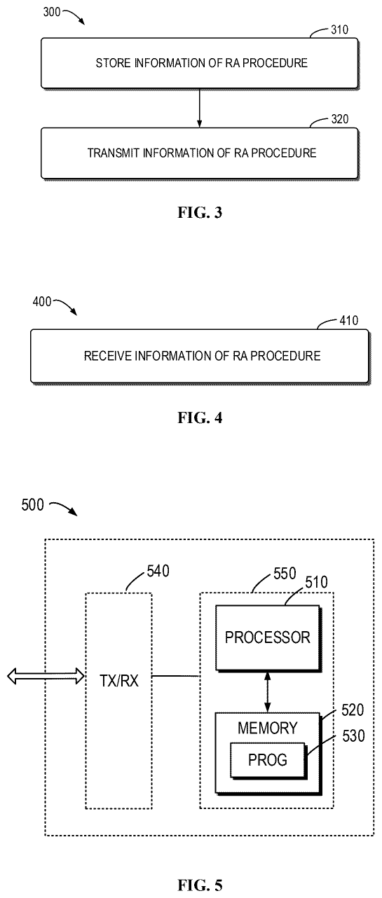

Accordingly, embodiments of the present disclosure provide methods of communication implemented at a terminal device and a network device. These methods will be described below with reference to FIGS. 3 and 4.

FIG. 3 illustrates an example method 300 of communication implemented at a terminal device in accordance with some embodiments of the present disclosure. For example, the method 300 may be performed at the terminal device 110 as shown in FIG. 1. For the purpose of discussion, in the following, the method 300 will be described with reference to FIG. 1. It is to be understood that the method 300 may include additional blocks not shown and/or may omit some blocks as shown, and the scope of the present disclosure is not limited in this regard.

At block 310, the terminal device 110 stores information of a RA procedure. The information of the RA procedure may comprise at least one of the following: first information regarding RA partition, second information regarding Msg3 repetition, third information regarding the RA procedure triggered due to none of SSBs associated with a CG resource for SDT has RSRP above threshold power, fourth information regarding the RA procedure triggered due to consistent LBT failure recovery, fifth information regarding the RA procedure triggered due to SCG activation, sixth information regarding the RA procedure triggered due to BFR for two sets of BFD-RSs, or seventh information regarding a TA report.

In some embodiments, the first information may comprise at least one of the following: a set of features associated with a set of RA resources selected for the RA procedure, a set of features applicable for the RA procedure but unassociated with a set of RA resources selected for the RA procedure, or a set of features applicable for the RA procedure.

In some embodiments, the second information may comprise measured RSRP of a downlink path loss reference obtained upon determination of whether Msg3 repetition is applicable for the RA procedure.

In some embodiments, the third information may comprise at least one of the following: an indication indicating that the RA procedure is triggered due to none of SSBs associated with the CG resource for SDT has RSRP above threshold power, an indication indicating that the RA procedure is triggered due to none of SSBs associated with the CG resource for SDT has RSRP above threshold power and there is UL data available for transmission, an index of the CG resource, information of the SSBs associated with the CG resource, or measured RSRP of the SSBs associated with the CG resource upon the triggering of the RA procedure.

In some embodiments, the fifth information may comprise at least one of the following: an indication indicating that the RA procedure is triggered due to the SCG activation, an indication indicating whether a beam failure occurs when the RA procedure for the SCG activation is triggered, or an indication indicating whether a TAT expiries or uplink un-synchronization occurs when the RA procedure for the SCG activation is triggered.

In some embodiments, the sixth information may comprise at least one of the following: an indication indicating that the RA procedure is triggered due to the BFR for the two sets of BFD-RSs, or an identity of a non-serving cell associated with one of the two sets of BFD-RSs.

In some embodiments, the seventh information may comprise at least one of the following: a TA value, or an integer number of slots greater than or equal to the TA value.

At block 320, the terminal device 110 transmits the information of the RA procedure to the network device 120.

In some embodiments, the terminal device 110 may transmit the information of the RA procedure in at least one of the following: a RA report, a connection establishment failure report, a RLF report, or a SHR.

In this way, RA information may be reported to a network in a more comprehensive way for newly introduced features and optimization of a RA configuration may be facilitated.

FIG. 4 illustrates an example method 400 of communication implemented at a network device in accordance with some embodiments of the present disclosure. For example, the method 400 may be performed at the network device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the network device 120 receives information of a RA procedure from the terminal device 110. The information of the RA procedure may comprise at least one of the following: first information regarding RA partition, second information regarding Msg3 repetition, third information regarding the RA procedure triggered due to none of SSBs associated with a CG resource for SDT has RSRP above threshold power, fourth information regarding the RA procedure triggered due to consistent LBT failure recovery, fifth information regarding the RA procedure triggered due to SCG activation, sixth information regarding the RA procedure triggered due to BFR for two sets of BFD-RSs, or seventh information regarding a TA report.

In some embodiments, the first information may comprise at least one of the following: a set of features associated with a set of RA resources selected for the RA procedure, a set of features applicable for the RA procedure but unassociated with a set of RA resources selected for the RA procedure, or a set of features applicable for the RA procedure.

In some embodiments, the second information may comprise measured RSRP of a downlink path loss reference obtained upon determination of whether Msg3 repetition is applicable for the RA procedure.

In some embodiments, the third information may comprise at least one of the following: an indication indicating that the RA procedure is triggered due to none of SSBs associated with the CG resource for SDT has RSRP above threshold power, an indication indicating that the RA procedure is triggered due to none of SSBs associated with the CG resource for SDT has RSRP above threshold power and there is UL data available for transmission, an index of the CG resource, information of the SSBs associated with the CG resource, or measured RSRP of the SSBs associated with the CG resource upon the triggering of the RA procedure.

In some embodiments, the fifth information may comprise at least one of the following: an indication indicating that the RA procedure is triggered due to the SCG activation, an indication indicating whether a beam failure occurs when the RA procedure for the SCG activation is triggered, or an indication indicating whether a TAT expiries or uplink un-synchronization occurs when the RA procedure for the SCG activation is triggered.

In some embodiments, the sixth information may comprise at least one of the following: an indication indicating that the RA procedure is triggered due to the BFR for the two sets of BFD-RSs, or an identity of a non-serving cell associated with one of the two sets of BFD-RSs.

In some embodiments, the seventh information may comprise at least one of the following: a TA value, or an integer number of slots greater than or equal to the TA value.

In some embodiments, the network device 120 may receive the information of the RA procedure in at least one of the following: a RA report, a connection establishment failure report, a RLF report, or a SHR.

In this way, a network may obtain RA information for newly introduced features and may optimize a RA configuration.

It is to be understood that the operations of methods 300 and 400 are similar as that described in connection with FIG. 2, and thus other details are not repeated here for concise.

### Example Implementation of Devices and Apparatuses

FIG. 5 is a simplified block diagram of a device 500 that is suitable for implementing embodiments of the present disclosure. The device 500 can be considered as a further example implementation of the terminal device 110 or the network device 120 as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises a circuitry configured to: store information of a random access procedure; and transmit the information of the random access procedure to a network device, the information of the random access procedure comprising at least one of the following: first information regarding random access partition, second information regarding Message 3 repetition, third information regarding the random access procedure triggered due to none of synchronization signal and physical broadcast channel blocks associated with a configured grant resource for small data transmission has reference signal receiving power above threshold power, fourth information regarding the random access procedure triggered due to consistent listen before talk failure recovery, fifth information regarding the random access procedure triggered due to secondary cell group activation, sixth information regarding the random access procedure triggered due to beam failure recovery for two sets of reference signals for beam failure detection, or seventh information regarding a timing advance report.

In some embodiments, a second terminal device comprises a circuitry configured to: receive, from a terminal device, information of a random access procedure comprising at least one of the following: first information regarding random access partition, second information regarding Message 3 repetition, third information regarding the random access procedure triggered due to none of synchronization signal and physical broadcast channel blocks associated with a configured grant resource for small data transmission has reference signal receiving power above threshold power, fourth information regarding the random access procedure triggered due to consistent listen before talk failure recovery, fifth information regarding the random access procedure triggered due to secondary cell group activation, sixth information regarding the random access procedure triggered due to beam failure recovery for two sets of reference signals for beam failure detection, or seventh information regarding a timing advance report.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-17. (canceled)

18. A method of a User Equipment (UE) comprising:
setting feature information in report information to indicate one or more features, which comprises at least one of Reduced Capability (RedCap) and Small Data Transmission (SDT), applicable for a random access procedure in a case where the random access procedure is completed successfully, and
sending, to a network, the report information.

19. The method of claim 18, wherein:
the report information comprises another feature information indicating second feature associated to a random-access resource used in the random-access procedure.

20. The method of claim 19, wherein:
the second feature comprises slice group.

21. The method of claim 18, wherein:
the report information comprises purpose information to include a purpose of triggering the random-access procedure, in a case where UE initiates Random Access Channel (RACH) due to consistent Listen Before Talk (LBT) failures.

22. A User Equipment (UE) comprising:
a memory storing instructions; and
a processor configured to execute the instructions to:
set feature information in report information to indicate one or more features, which comprises at least one of Reduced Capability (RedCap) and Small Data Transmission (SDT), applicable for a random access procedure in a case where the random access procedure is completed successfully, and
send, to a network, the report information.

23. The UE of claim 22, wherein:
the report information comprises another feature information indicating second feature associated to a random-access resource used in the random-access procedure.

24. The UE of claim 23, wherein:
the second feature comprises slice group.

25. The UE of claim 22, wherein:
the report information comprises purpose information to include a purpose of triggering the random-access procedure, in a case where UE initiates Random Access Channel (RACH) due to consistent Listen Before Talk (LBT) failures.
